(19) United States
(12) Patent Application Publication
(10) Pub. No.: US 2011/0305812 A1
(43) Pub. Date: Dec. 15, 2011

(54) FOOD COMPOSITION AND METHOD FOR PRODUCING THE SAME

(75) Inventor: Kayo FUJIWARA, Culver City, CA (US)

(73) Assignee: House Foods America Corporation, Garden Grove, CA (US)

(21) Appl. No.: 12/814,036

(22) Filed: Jun. 11, 2010

(51) Int. Cl. A23J 3/24; A23J 3/16

(52) U.S. Cl. 426/565; 426/564

(57) ABSTRACT

The present invention provides a means for preventing syneresis and imparting freeze/thaw stability to a food composition containing pureed soybean curd such as tofu puree and water. A first aspect of the present invention relates to a food composition containing pureed soybean curd (A), a foaming agent (B), a heat-coagulable substance (C), a stabilizer (D) and water, solidified by a heat treatment and having air bubbles dispersed therein, and a method for producing the same. A second aspect of the present invention relates to a food composition, containing pureed soybean curd (A), a heat-coagulable substance (C), carrageenan (D) and water, solidified by a heat treatment and containing water in an amount of 45 to 75% by mass, and a method for producing the same.

### BACKGROUND OF THE INVENTION

1. Field of the Invention

The present invention provides a food composition containing pureed soybean curd and a method for producing the same.

2. Background Art

As a cheesecake, for example, a New York cheesecake having creamy and soft texture in which small air bubbles are dispersed is known. The cheesecake contains fats, oils, and dairy ingredients, etc. in large amounts and thus is generally high in calories.

A high calorie component such as cheese can be substituted by a low-calorie alternative such as tofu. A food composition using tofu in place of, or in part of dairy ingredients is recognized. For example, U.S. Pat. No. 4,678,676 discloses a method of producing a cheese-like emulsified food by kneading a blend essentially containing tofu, a fat, oil, egg whites, and carrageenan, followed by heating. Soy protein in the tofu and egg whites serve as heat-coagulable substances are gelatinized by heat to form a gel, which is considered to be stabilized by the action of carrageenan (Column 4, lines 13 to 17). The blend is subjected to a deaeration step before heating in order to prevent foaming (Column 4, lines 3 to 7). By virtue of the deaeration step, a food having a “cheese-like texture” and containing no air bubbles can be obtained. The food proposed by U.S. Pat. No. 4,678,676 is a cheese-like food, which differs in object from the New York cheesecake by having a soft texture.

On the other hand, U.S. Pat. No. 4,425,369 discloses a technique for preparing a cheesecake and describes raw-materials for producing a cheesecake, which is an oil-in-water emulsion containing a cheese, a milk material, water and an emulsifying agent and capable of homogeneously foaming. In this publication, the aforementioned materials are whipped; egg whites and meringue serve as a heat-coagulable substance that are mixed and baked to produce a baked cheesecake (Column 3, lines 35 to 42).

JP Patent Publication (Kokai) No. 2005-218407A discloses a method for producing a souffle-like food base having tolerance to freezing or refrigeration by mixing materials derived from eggs and milk while introducing air to obtain a viscous preparation. This publication discloses that the souffle-like food base frozen is baked in an oven (paragraph 0026).

### SUMMARY OF THE INVENTION

An investigation was made to obtain a food composition having a soft and creamy texture as mentioned earlier in this section, and reduced amounts of e.g., fats and oils. The present inventor tried to prepare a food composition containing tofu as a partial or full replacement for the dairy ingredients, and having a structure in which small air bubbles are homogeneously dispersed. Furthermore, having a higher water content than commercially available New York cheesecakes which generally have a water content of about 43% by mass. In the experiment, a food composition with water content higher than those of the New York cheese cakes, (for example, about 50% by mass) was prepared.

During the experiment for preparing a food composition with a high water content, the present inventor encountered problems associated with using tofu, which contains protein without freeze-thaw stability and a large amount of water (usually, 70 to 90% by mass). To explain the problems encountered more specifically, one problem arises when a food composition having a cheesecake-like texture and containing tofu and water is stored in refrigeration conditions. A significant amount of water is dissociated from the composition, thus making the texture extremely degraded. This problem is particularly significant in food compositions (for example, food composition similar to a New York cheesecake) with soft and creamy texture, having numerous small air-bubbles dispersed therein, and a high water content. When water dissociates, the texture of the food composition changes and a cake-like appearance thereof cannot be retained. At the same time, the food composition loses a desired moist, light, soft, and creamy New York Cheesecake-like texture, flavor, and “melt in the mouth” texture. New York Cheesecake is a dessert having rich cheese flavor and aroma with light, creamy, and soft texture, usually made with cream cheese, eggs, sugar, and other additional ingredients poured and baked in a pan. The term “New York Cheesecake-like” food refers to a food having the similar texture and flavor to it.

Another problem arises during the freezing process of the food composition. The ice crystals are grown larger within the matrix containing coagulated soymilk (Tofu). Therefore, after the food composition is thawed, the texture tends to be dry, spongy, and loses the “melt in the mouth” texture. The texture and mouthfeel are significantly deteriorated compared to those before being frozen, and the food composition no longer has a cheesecake-like texture. Thus distributing such products under frozen condition or storing them for a long period of time are unattainable.

U.S. Pat. No. 4,425,369 and JP Patent Publication (Kokai) No. 2005-218407A disclose that a heat treatment is applied to an emulsion or the like can be prepared by mixing heat-coagulable substances such as egg whites and meringue. However, any other ingredients for stabilizing the texture except heat-coagulable substances are not used in the technique disclosed in these publications. The present inventor confirmed that even if a food composition containing the pureed soybean curd and water is produced by the technique, syneresis and deterioration in texture cannot be prevented and tolerance to freezing cannot be imparted to the food composition.

Under the circumstances, an object of the present invention is to provide a means for preventing syneresis and deterioration in texture of a food composition containing the pureed soybean curd such as tofu puree and water, and imparting tolerance to freezing within the food composition.

The present inventors provide the following invention as means for solving the problems.

(1) A food composition containing pureed soybean curd (A), a foaming agent (B), a heat-coagulable substance (C), a stabilizer (D) and water, solidified by a heat treatment and having air bubbles dispersed therein.

(2) The food composition of item (1), containing soy protein in an amount of 0.4 to 15% by mass on a dry basis relative to the total mass of the food composition.

(3) The food composition of item (1), containing the stabilizer (D) in an amount of 0.01 to 5% by mass on a dry basis relative to the total mass of the food composition.

(4) The food composition of item (1), containing water in an amount of 45 to 75% by mass.

(5) The food composition of item (1), which is frozen.

(6) A kit for preparing the food composition of item (1), containing pureed soybean curd (A), a foaming agent (B), a heat-coagulable substance (C) and a stabilizer (D) as components.

(7) A food composition containing pureed soybean curd (A), a heat-coagulable substance (C), lambda carrageenan (D) and water, solidified by a heat treatment and containing water in an amount of 45 to 75% by mass.

(8) The food composition of item (7), containing soy protein in an amount of 0.4 to 15% by mass on a dry basis relative to the total mass of the food composition.

(9) The food composition of item (7), containing lambda carrageenan (D) in an amount of 0.01 to 5% by mass on a dry basis relative to the total mass of the food composition.

(10) The food composition of item (7), which is frozen.

(11) A kit for preparing the food composition of item (7), containing pureed soybean curd (A), a heat coagulable substance (C) and lambda carrageenan (D) as components.

(12) A method for producing a food composition, including the steps of

providing a blend containing pureed soybean curd (A), a foaming agent (B), a heat-coagulable substance (C), a stabilizer (D) and water and having air bubbles dispersed therein, and applying a heat treatment to the blend.

(13) The method for producing the food composition of item (12), further having a step of freezing the blend after the heat treatment.

(14) The method for producing the food composition of item (12), in which pureed soybean curd (A) is tofu puree prepared by liquefying tofu until smooth.

(15) The method for producing the food composition of item (12), in which the blend contains soy protein in an amount of 0.4 to 15% by mass on a dry basis and the stabilizer (D) in an amount of 0.01 to 5% by mass on a dry basis relative to the total mass of the food composition.

(16) A method for producing a food composition, including the steps of

preparing a blend containing pureed soybean curd (A), a heat-coagulable substance (C), lambda carrageenan (D) and water, and applying a heat treatment to the blend.

(17) The method for producing the food composition of item (16), further having a step of freezing the blend after the heat treatment.

(18) The method for producing the food composition of item (16), in which pureed soybean curd (A) is tofu puree prepared by liquefying tofu until smooth.

(19) The method for producing the food composition of item (16), in which the blend contains the soy protein in an amount of 0.4 to 15% by mass on a dry basis and lambda carrageenan (D) in an amount of 0.01 to 5% by mass on a dry basis relative to the total mass of the food composition.

Note that, as disclosed in U.S. Pat. No. 4,678,676, a cheese-like food using tofu as a complete or partial substitution of dairy ingredients is known. However, the food disclosed in the publication is a deaerated cheese-like food containing no air bubbles. A cheese-containing food, in which small air bubbles are introduced and dispersed therein, while containing tofu as a complete or partial substitution of dairy ingredients resulting in reduced calorie, cholesterol, and fat contents, has not yet been provided in the art.

According to the present invention, in a food composition containing pureed soybean curd such as tofu puree and water, it is possible to prevent syneresis and texture deterioration, and simultaneously impart tolerance to freezing.

### DETAILED DESCRIPTION OF THE PREFERRED EMBODIMENTS

Preferred embodiments of the present invention will be described below.

### (1) Ingredients

### (1)-1 Pureed Soybean Curd (A)

The pureed soybean curd is a coagulated soymilk and the like, liquefied by mashing, grinding, or pureeing with a blender, grater, high shear mixer, homogenizer, static mixer, or the like, such that particles of the soybean curd are indistinctive. “The pureed soybean curd” used in the present invention comprises soymilk and a mixture containing coagulant(s) also used in conventional tofu preparation, added to the soymilk in the same amount as that used when tofu is prepared. If the mixture of coagulant(s) is added to soymilk for preparation of tofu (soybean curd) which is further processed into tofu puree, it is possible to obtain a food composition having a moist, soft, New York cheesecake-like texture, with the “melt in the mouth” texture. Preferably, the pureed soybean curd is prepared such that 2.5 to 18% by mass of the product is a solid derived from soy protein. Additionally, the pureed soybean curd is prepared such that 65 to 95% by mass of the product is water.

The soybean curd typically refers to tofu as momen tofu (firm and pressed) and kinugoshi tofu (soft and silken) obtained by a customary method of treating soymilk with heat and then adding/mixing a coagulating agent. In the present invention, pureed soybean curd is referred to as “tofu puree”.

In the specification, it is provided that the ratio of an ingredient in a composition is expressed by percentage of the dry mass of the ingredient relative to the total mass of the composition including water content. For example, the amount of soy protein in the pureed soybean curd is expressed by the percentage of the soy protein (dry mass) relative to the pureed soybean curd (wet mass). The ratio of each ingredient formulated in the food composition is expressed by the percentage of the ingredient (by mass) relative to the final product (total mass of the food composition including water content).

Examples of the coagulating agents may include calcium salts such as calcium chloride and calcium sulfate, magnesium salts such as magnesium chloride and Nigari, and acids such as glucono delta lactone. These coagulating agents may be used alone or in combination. Usage level(s) of coagulating agent(s), for example, 0.1 to 1.0 wt % relative to soymilk may be preferably exemplified.

The pureed soybean curd is added to the food composition such that soy protein content of the final product is preferably 0.4 to 15% by mass on dry basis, and more preferably, 1 to 5% by mass on dry basis.

When the content of pureed soybean curd on a soy protein basis is less than the minimum percentage mentioned earlier in this section, significant reductions in calorie, fat, and cholesterol by using the pureed soybean curd as a low calorie alternative for dairy ingredients, etc., cannot be expected.

When the content of pureed soybean curd exceeds the maximum percentage mentioned earlier in this section, it appears to be more difficult to prevent syneresis and provide a freeze/thaw stability to a food composition having a high water content and air bubbles dispersed.

When the content of pureed soybean curd falls within the range, it is possible to prevent syneresis, provide a freeze/thaw stability, and prevent texture deterioration even if a food composition has air bubbles and/or a high water content.

### (1)-2 (B) Foaming Agent (Whipping Agent)

The type of foaming agent to be used in this invention is not limited to any particular substance as long as it can homogeneously introduce air bubbles into a blend of ingredients (batter) and is permitted to be used in food products. Examples of foaming agents include egg albumin (egg whites, meringue), milk fat, and milk protein (whipped cream). Among them, egg albumin (egg whites and meringue) is preferably used since it also acts as a heat-coagulable substance (described later).

The foaming agent may be used to aerate the batter at any time as long as it can homogeneously introduce air bubbles into a food composition. Generally, it is preferred that egg whites, (a food ingredient containing egg albumin as a foaming agent,) is beaten to introduce air therein to make meringue, which is mixed with a blend of the rest of the ingredients. Alternatively, heavy cream containing milk fat and milk protein as foaming agents is beaten to obtain whipped cream, which may be mixed with a blend of the rest of the ingredients. Other than these, enzymatically modified soy protein or milk protein, gum acacia, glycerol esters of fatty acids, acetylated distarch phosphate, acetylated monoglyceride, and alginic acid and the like can be used as a foaming agent.

When a foaming agent is protein based, the content of protein derived from the foaming agent is preferably 0.05 to 3% by mass on a dry basis, and more preferably, 0.1 to 1.5% by mass on a dry basis.

When the content of a foaming agent falls within the range, a proper amount of air bubbles are dispersed in a food composition. As a result, a food composition having soft and consistent texture can be easily prepared.

When the content of a foaming agent is less than the minimum percentage mentioned earlier in this section, the amount of air bubbles dispersed in the food composition tends to be low and may affect freeze/thaw stability and syneresis.

When the content of a foaming agent exceeds the maximum percentage mentioned earlier in this section, a food composition significantly expands during the heat treatment and shrinks as cooling down affecting the shape of the resultant food composition in some cases.

### (1)-3 (C) Heat-Coagulable Substance

A heat-coagulable substance is mixed into a blend of other ingredients to make the batter. When the batter containing a heat-coagulable substance is heated, it is solidified by heat coagulation, to be more specific, thermo-irreversible gelation. The food composition “solidified” refers to a food composition having shape retaining property, preferably having texture similar to conventional cheesecake or soufflé texture in the presence or absence of foams. Furthermore hardness refers to a food composition having the following physicochemical properties described later in the “Example”. The batter which is to be subjected to heat coagulation may or may not be aerated by the action of a foaming agent. The type of heat coagulable substance is not limited to any particular substance as long as it has heat-coagulable property, and is permitted to be used in food products. Examples of the heat-coagulable substance include egg whites, meringue, whey protein, soy protein, the plasma protein, wheat, gluten, and starches.

If the heat-coagulable substance added to a food composition contains protein as an active component, the content of protein derived from the heat coagulable substance is preferably 0.05 to 3% by mass on a dry basis, and more preferably 0.1 to 1.5% by mass on a dry basis.

When the content of heat-coagulable substance falls within the range, it is possible to easily prepare a food composition having shape retaining properties, soft and consistent texture, creamy and smooth mouthfeel, and having stable, small air bubbles dispersed therein. This results in a consistency resembling conventional cheesecakes.

When the amount of a heat-coagulable substance is less than the minimum percentage mentioned earlier in this section, the resultant food composition may not be sufficiently aerated and desired freeze/thaw stability and syneresis reduction may not be expected.

When the amount of a heat-coagulable substance exceeds the maximum percentage mentioned earlier in this section, the food composition tends to be tough, lacks creaminess and “melt in the mouth” texture.

If a heat-coagulable substance, (such as egg whites and meringue) also functions as a foaming agent, the content in a food composition may be either the amount defined for the heat-coagulable substance, the amount defined for the foaming agent, or the sum of those amounts.

### (1)-4 (D) Stabilizer

A stabilizer is added to increase cohesiveness and freeze/thaw stability to a food composition, and to prevent syneresis and texture deterioration by functioning synergistically with a heat-coagulable substance. When a stabilizer is added, it is possible to obtain a high water-content food composition having smooth, soft, creamy, and “melt in the mouth” texture. The freeze/thaw stability refers to the ability of a food composition to maintain the excellent organoleptic quality and the same chemical and physical properties after freezing and thawing, for example, by suppressing growth of ice crystals during freezing.

Examples of the stabilizer include lambda carrageenan, iota carrageenan, kappa carrageenan, xanthan gum, locust bean gum, guar gum, sodium alginate, cellulose, microcrystalline cellulose and modified starch. These can be used alone or in combination of two types or more. To achieve the aforementioned properties of a food composition, lambda carrageenan is the most desirable choice for a stabilizer followed by iota carrageenan. For the same reason, lambda carrageenan is preferably used alone. It is preferred that lambda carrageenan is being prepared before incorporated into the rest of the ingredients by dispersing in a liquid, (the liquid may contain other ingredients or may be constituent of one or more of the other ingredients) and mixing while applying heat until it is, completely dissolved.

A stabilizer is added to a food composition such that the content of a stabilizer is preferably in an amount of 0.01 to 5% by mass on a dry basis, and more preferably in an amount of 0.1 to 3% by mass on a dry basis.

When the amount of stabilizer falls within the range, it is possible to prepare a food composition having soft and consistent texture, freeze/thaw stability, minimized syneresis, and texture deterioration.

When the amount of stabilizer is less than the minimum percentage mentioned earlier in this section, the desired functions of the stabilizer may not be expected.

When the addition amount of stabilizer exceeds the maximum percentage mentioned earlier in this section, it tends to be difficult to prepare a food composition having soft and “melt in the mouth” texture.

### (1)-5 Water

The food composition of the present invention contains water. The water may be added as is or as a component of other ingredients, for example, water contained in the pureed soybean curd. According to the present invention, the water content of a food composition solidified by a heat treatment is preferably 45 to 75% by mass, and more preferably, 50 to 60% by mass.

When the water content falls within the range, it is possible to prepare a food composition having a soft and stable texture, freeze/thaw stability, minimized syneresis and texture deterioration. A food composition having the water content within the range is relatively rich in water and low in calorie and fat.

When the water content is less than the minimum percentage mentioned earlier in this section, it is difficult to reduce calorie and fat content of the food composition sufficiently.

When the water content exceeds the maximum percentage mentioned earlier in this section, it tends to be difficult to prepare a food composition having a consistent, light and creamy texture resembling New York Cheesecake, minimized syneresis, and freeze/thaw stability.

### (2) Other Ingredients

### (2)-1 Ingredients Used to Provide Syneresis Control, Freeze/Thaw Stability, and Fat-Like Mouth Feel to Food Composition

Examples of the ingredients used to prevent syneresis and to provide freeze/thaw stability and fat-like mouth feel to a food composition are polysaccharides with a low degree of polymerization (for example, a degree of polymerization of 100 or less), and modified starch. Specifically, maltodextrin (degree of polymerization: 3 to 19), is most preferably used in an amount of 1 to 15% by mass on a dry basis in a food composition, but dextrin, dietary fibers, inulin, modified starches and the like can be also used alternatively.

By virtue of using these ingredients, total solids in the water soluble portion of a food composition is increased. As a result, syneresis which takes place during refrigerated storage of a food composition is minimized, ice crystal growth during freezing is suppressed, and fat-like mouth feel is imparted. Of these materials providing such favorable effects, dextrin, in particular, maltodextrin is preferred. This is because maltodextrin produces the aforementioned effects without increasing sweetness and playing a role in stabilizing air bubbles in a food composition and improving texture thereof.

### (2)-2 Additional Ingredients

Additional ingredients are any substances such as fats, oils, egg yolks, emulsifying agents, dairy and dairy alternative ingredients, and foam stabilizers that can be added as long as they are permitted to be used in food products.

As for fats and oils, any kind of lipids derived from animals and plants can be used. Examples of fats and oils include soybean oil, corn oil, palm oil, rapeseed oil, canola oil, cacao butter, milk fat, coconut oil, lard, and fish oil. These fats and oils can be a component of other ingredients, e.g., sour cream, butter and margarine. In order to improve flavor of a food composition, it is preferred that fats and oils are added to a food composition in an amount of 1 to 15% by mass.

Egg yolks is preferably added to a food composition in an amount of 0.1 to 10% by mass on a dry basis in order to improve flavor and emulsion stability of the food composition.

The emulsifying agent is added to a food composition preferably in an amount of 0.1 to 3% by mass on a dry basis in order to improve emulsion stability and freeze/thaw stability of the food composition. Examples of the emulsifying agent include lecithin, glycerin fatty acid esters, sucrose fatty acid esters, propylene glycol fatty acid esters and sorbitan fatty acid esters, and lecithin is most preferably used.

The dairy and dairy alternative ingredients are added in order to impart dairy flavor to a food composition and to mask undesirable flavor components that come from the soybeans. The dairy ingredients are added to a food composition preferably in an amount of 1 to 25% of solid by mass on a dry basis. Examples of the dairy ingredients include cheeses (e.g., cream cheese, soybean cheese, low-fat cream cheese, Neufchatel cheese, mascarpone cheese, cottage cheese, ricotta cheese), creams, sour cream, yogurt, whole milk powder, nonfat dry milk, butter milk powder, whey, dry whey powder, whey protein concentrate, casein, sodium caseinate, and lacto albumin.

The cheese ingredients and other dairy ingredients impart flavors resembling the conventional cheesecake and the distinctive rich and sweet dairy flavors to the food composition.

The foam stabilizer can be used primarily to prevent small air bubbles in the foam from breaking down during the preparation of the food composition. Examples of the foam stabilizers include potassium bitartrate and disodium pyrophosphate. A foam stabilizer is added to the food composition preferably in an amount of 0.01 to 0.5% by mass on a dry basis.

### (3) Production Method

The food composition of the present invention can be produced in accordance with the following procedure.

### (3)-1 Preparation of Blend of Ingredients

First and the foremost, the blend of ingredients containing pureed soybean curd (A), a heat-coagulable substance (C), a stabilizer (D) and water as essential components is prepared. The blend may be referred to as “batter” in the present specification. When an aerated food composition is produced, the batter comprising pureed soybean curd (A), a foaming agent (B), a heat-coagulable substance (C) and a stabilizer (D) and water as the essential ingredients, and having air bubbles dispersed therein is prepared.

Procedures for mixing ingredients to prepare the batter and means for aerating the batter are not limited. For example, the batter can be aerated simultaneously while being mixed with all the other ingredients including a foaming agent such as egg whites (unwhipped) and a foam stabilizer to obtain the batter having air bubbles homogeneously dispersed therein. Alternatively, meringue prepared in advance by beating egg whites and foam stabilizer together can be mixed with the rest of the ingredients to prepare the batter having air bubbles homogeneously dispersed therein.

The viscosity of the batter is preferably about 2000 mPs to 15000 mPs, which is measured in the following conditions.

Viscometer Model: Brookfield DV-II+Pro

Spindle used: S64

Rotational speed of spindle: 50 rpm

Sample temperature: 25° C.

### (3)-2 Heat Treatment

Next, the batter is subjected to a heat treatment. Specifically, the batter is heat treated under the conditions that a heat-coagulable substance is solidified and simultaneously hardness is imparted by a stabilizer. The food composition obtained by the heat treatment has an irreversibly solidified structure having shape retention property. In the case where the batter contains homogeneous air bubbles, the resultant food composition obtained by the heat treatment has a structure irreversibly solidified and having shape retention property while maintaining the air bubbles homogeneously dispersed.

Means for applying heat is not limited and any means such as baking, steaming, microwave heating can be used as long as it heats the batter to satisfy the aforementioned conditions. With a view to imparting a flavor, aroma, and appearance as such brought out when a food composition is baked until having a nice brown surface, baking is most preferably employed.

Conditions for a heat treatment is predominantly determined by the maximum temperature of the center portion of the batter to reach, which is preferably 65 to 100° C., more specifically, 75 to 85° C. Usually, the heat treatment is applied to the batter that is poured in a pan of about 100 to 1800 cc capacity. After the heat treatment is performed, the food composition can be cooled accordingly.

When the center temperature of the batter during the heat treatment falls within the range, the function (heat coagulation) of a heat-coagulable substance and a stabilizer are sufficiently utilized to prepare a resultant food composition with soft and consistent texture, minimum syneresis, texture deterioration, and freeze/thaw stability.

When the center temperature of the batter during the heat treatment does not reach the lowest temperature mentioned earlier in this section, the function (heat coagulation) of a heat-coagulable substance and a stabilizer are not sufficiently utilized. As a result, the resultant food composition may be lacking the desired organoleptic and physicochemical properties.

When the center temperature of the batter during the heat treatment exceeds the highest temperature mentioned earlier in this section, a food composition may have some of the desirable properties brought out by the heat-coagulable substance and the stabilizer. However, a food composition prepared with an excessive heat treatment tends to lack syneresis control. As a result, smoothness and “melt in the mouth” texture tend to be lost.

### (4) Product

The food composition produced by the aforementioned procedure desirably has at least one of the properties particularly described below.

(4)-1

The water content of a food composition is preferably 45 to 75% by mass, and more preferably 50 to 60% by mass.

(4)-2

The fat content of a food composition is preferably 1 to 15% by mass, and more preferably 5 to 12% by mass. When the fat content of a food composition falls within the range, flavor derived from fats and oils is sufficiently imparted to obtain a food composition having a relatively low calorie and fat-like texture resembling the conventional cheesecakes.

(4)-3

The hardness of a food composition is measured by a rheometer manufactured by Fudou Kougyou Inc., with a adaptor of 20 mm diameter. The hardness of a food-composition sample measured at a temperature of 20° C. is preferably 20 to 150 g, and more preferably 40 to 120 g. All hardness values described in the specification including Examples falls into the range mentioned above, and measured under conditions described above.

When the hardness of a food composition falls within the range, properties such as soft, consistent, smooth, creamy, and “melt in the mouth” texture, and an ability to maintain air bubbles homogeneously dispersed therein will be expected.

### (4)-4 Application Form

The food composition of the present invention can be served as the same or similar manner as that of cheesecake, (cheese) souffle, mousse, pâté, and the like.

When a food composition prepared by applying a heat treatment is frozen, any freezing means may be employed; however, quick freezing is preferred in order to reduce the size of ice crystals to be grown. Quick freezing is preferably performed in such conditions that a food composition is passed through a temperature zone (maximum crystal formation zone) of about −1° C. to −5° C. as quick as possible.

A food composition also can be stored under refrigeration conditions.

A food composition stored in a freezer or a refrigerator can be eaten as is, or eaten after being thawed, or after it is further heated by e.g., baking. A food composition heated by steaming may be stored in a freezer or a refrigerator as dough, and solidified by heating it. e.g., baking when it is served.

### (5) Kit (Cake Mix Kit)

The present invention further provides a kit (which may be provided as a cake mix kit) for preparing the aforementioned food composition. The kit contains pureed soybean curd (A), a heat-coagulable substance (C), and a stabilizer (D) as the essential components. A kit for preparing a food composition having air bubbles dispersed therein, additionally contains a foaming agent (B) as a component. The kit may further contain other ingredients depending upon the desired properties of the final product made from the kit. Ingredients may be previously weighed so as to satisfy the mixing ratios specified by the specification. The ingredients may be mixed in advance and blended into the kit, or contained as separate packages in the kit.

It is preferred that the kit further contains a manual, which explains a procedure for preparing a food composition from the ingredients supplied in the kit in accordance with the method in the present invention. The manual may provide a recipe including the amount of water to be added and step-by-step directions for mixing and baking. The manual for a kit for preparing a food composition having air bubbles dispersed therein may further provide information on a procedure to aerate the batter. The manual of a kit containing carrageenan (preferably, lambda carrageenan) as a component may further provide information on a procedure to dissolve carrageenan in a liquid while applying heat.

Next, the present invention will be specifically described below as examples. However, the present invention is not limited to these Examples.

### EXAMPLE 1

### <Ingredients>

TABLE 1

| Ingredients | Usage (% by mass) |
|---|---|
| (A) Tofu puree | 40% |
| Cream cheese | 25% |
| Granulated sugar | 10% |
| Sour cream | 10% |
| (B)(C) Egg whites | 6% |
| Maltodextrin, dextrose equivalent = 10 | 4% |
| Egg yolks | 3% |
| Flavor (vanilla) | 1% |
| Powder lecithin | 0.5% |
| (D) λ (lambda) carrageenan | 0.5% |
| | 100% |

Note that the water content of each ingredient is; 62 to 68% for the Cream cheese, 70 to 80% for the Sour cream, 85 to 90% for the Egg whites, and 50 to 57% for the Egg yolks.

### <Production Method>

1) Tofu puree was prepared as follows.

Soymilk (about 15 L) adjusted to contain about 14% of total solids by mass was mixed with calcium sulfate (40 g) and glucono delta-lactone solution (containing 10 g of glucono delta-lactone on a dry basis), hold to coagulate and cooled. The cold tofu was pureed by a High Shear Mixer.

About 14% by mass of the tofu puree is comprised of a solid from soybean and about 86% by mass of the tofu puree is comprised of water.
2) One half the amount of tofu puree and carrageenan were mixed, and heated to 80° C. while stirring and then cooled.
3) A bowl was set on a stand mixer. Egg whites were placed in the bowl and then beaten until soft peak formed.
4) The mixtures prepared in the steps 2) and 3), and all the rest of the ingredients were combined together in a bowl and blended with the mixer to prepare the aerated batter.
5) The batter was poured into a cake pan of about 1500 cc with a graham cracker crust base pressed on the bottom, and baked in an oven until the center temperature of the batter reached about 78° C.

### <Cheesecake>

A cheesecake prepared in the aforementioned steps, a cheesecake further stored in a refrigerator for 3 days, and a cheesecake further frozen and stored for 14 days had the following properties.

TABLE 2

| | Cheesecake | Cheesecake | Cheesecake |
|---|---|---|---|
| | immediately after | stored in a | stored in a |
| | preparation | refrigerator | freezer |
| Water content | About 55% by mass | same as on | same as on |
| | | the left | the left |
| Fat content | About 9.72% by mass | same as on | same as on |
| | | the left | the left |
| Hardness | 75 g | same as on | same as on |
| | | the left | the left |
| Flavor/ | Texture homogeneously | same as on | same as on |
| texture/ | contains air bubbles. | the left | the left |
| quality | Moist, soft, creamy, | | |
| | smooth, and melt in the | | |
| | mouth texture, rich | | |
| | cheesecake flavor were | | |
| | obtained | | |
| Syneresis | Not observed | same as on | same as on |
| | | the left | the left |

### COMPARATIVE EXAMPLE 1

### Defective Product

A cheesecake was prepared in the same manner as in Example 1 except that soymilk containing 14% by mass of a solid substance (soy protein: 7.31% by mass) on a dry basis and 86% by mass of water was used in place of tofu puree. The cheesecake immediately after preparation had the following properties

TABLE 3

| | Cheesecake immediately |
|---|---|
| | after preparation |
| Water content | About 55% by mass |
| Fat content | About 9.72% by mass |
| Flavor/texture/quality | The aeration in structure was |
| | low. Texture was heavy and |
| | gooey. Neither light, creamy, |
| | smooth, nor melt in the mouth |
| | texture were obtained. No |
| | cheesecake-like flavor and |
| | texture were obtained. |
| Syneresis | Not observed |

### EXAMPLES 2 TO 4

A cheesecake was prepared in the same manner as in Example 1 except that the following stabilizers were separately used in place of A carrageenan (0.5%). Note that, in Examples 2 and 3, when the blend of step 2), which was prepared by mixing with tofu puree while heating followed by cooling was mixed with other ingredients in step 4), it was necessary to use a mixer to break a gel in order to obtain a homogenous blend. A cheesecake immediately after prepared, a cheesecake further stored in a refrigerator for 3 days, and a cheesecake further frozen and stored in a freezer for 14 days had the following properties. Compared to Example 1, souffle-like texture, melt in the mouth texture and satisfactory flavor were obtained.

TABLE 4

| | | Example 2 | Example 3 | Example 4 |
|---|---|---|---|---|
| Stabilizer | | ι (Iota) | κ (Kappa) | Xanthan |
| | | carrageenan 0.5% | carrageenan 0.5% | gum 0.5% |
| Cheesecake | Water | 55 | 55 | 55 |
| immediately after | Fat | 9.72 | 9.72 | 9.72 |
| preparation | Hardness | 76 | 108 | 337 |
| | Flavor/ | Although texture | Although texture | Although texture |
| | texture/ | was not as smooth | was slightly pasty | was rubbery and |
| | quality | as Example 1, | and.less creamy | less creamy |
| | | cheesecake-like | compared to | compared to |
| | | melt in the mouth | Example 1, | Example 1, |
| | | texture and good | cheesecake-like | cheesecake-like |
| | | flavor were | melt in the mouth | melt in the mouth |
| | | obtained. | texture and good | texture and good |
| | | | flavor were | flavor were |
| | | | obtained. | obtained. |
| | Syneresis | Rather significant | Not | Not |
| | | than Example 1 | significant | significant |
| | | when left at an | | |
| | | ambient | | |
| | | temperature | | |
| Cheesecake | Water | 55 | 55 | 55 |
| stored in a | Fat | 9.72 | 9.72 | 9.72 |
| refrigerator | Hardness | 76 | 108 | 337 |
| | Flavor/ | same as the | same as the | same as the |
| | texture/ | above column | above column | above column |
| | quality | | | |
| | Syneresis | same as the | same as the | same as the |
| | | above column | above column | above column |
| Cheesecake | Water | 55 | 55 | 55 |
| stored in a | Fat | 9.72 | 9.72 | 9.72 |
| freezer | Hardness | 76 | 108 | 337 |
| | Flavor/ | same as the | same as the | same as the |
| | texture/ | above column | above column | above column |
| | quality | | | |
| | Syneresis | same as the | same as the | same as the |
| | | above column | above column | above column |

In the above table, second left column, “water” indicates a water content and “Fat” indicates a fat content.

### EXAMPLE 5

A cheesecake was prepared in the same manner as in Example 1 except that step 3′) was employed in place of step 3) and step 4) of the production method shown in Example 1. In step 3′), a bowl was set on a stand mixer. The blend of tofu puree and λ carrageenan prepared in step 2) and other ingredients (including the other half amount of tofu puree not used in step 2)) were added to the bowl and stirred to prepare a homogenous blend. The blend obtained in step 3′) differs from the blend obtained in step 4) of Example 1, in that no air bubbles were intentionally incorporated. A cheesecake immediately after prepared, a cheesecake further stored in a refrigerator for 3 days, and a cheesecake further frozen and stored for 14 days had the following properties.

TABLE 5

| | Cheesecake | Cheesecake | Cheesecake |
|---|---|---|---|
| | immediately after | stored in a | stored in a |
| | preparation | refrigerator | freezer |
| Water content | About 55% by mass | same as the | same as the |
| | | left column | left column |
| Fat content | About 9.72% by mass | same as the | same as the |
| | | left column | left column |
| Hardness | 89 g | same as the | same as the |
| | | left column | left column |
| Flavor/ | Moist, rich and soft | same as the | same as the |
| texture/ | melt in the mouth | left column | left column |
| quality | texture and rich | | |
| | cheesecake flavor | | |
| | were obtained. | | |
| Syneresis | Not significant | same as the | same as the |
| | | left column | left column |

What is claimed is:

1. A food composition comprising pureed soybean curd (A), a foaming agent (B), a heat-coagulable substance (C), a stabilizer (D) and water, solidified by a heat treatment and having air bubbles dispersed therein.

2. The food composition according to claim 1, comprising soy protein in an amount of 0.4 to 15% by mass on a dry basis relative to the total mass of the food composition.

3. The food composition according to claim 1, comprising the stabilizer (D) in an amount of 0.01 to 5% by mass on a dry basis relative to the total mass of the food composition.

4. The food composition according to claim 1, comprising water in an amount of 45 to 75% by mass.

5. The food composition according to claim 1, which is frozen.

6. A kit for preparing the food composition according to claim 1, comprising pureed soybean curd (A), a foaming agent (B), a heat-coagulable substance (C) and a stabilizer (D) as components.

7. A food composition comprising pureed soybean curd (A), a heat-coagulable substance (C), lambda carrageenan (D) and water, solidified by a heat treatment and containing water in an amount of 45 to 75% by mass.

8. The food composition according to claim 7, comprising soy protein in an amount of 0.4 to 15% by mass on a dry basis relative to the total mass of the food composition.

9. The food composition according to claim 7, comprising lambda carrageenan (D) in an amount of 0.01 to 5% by mass on a dry basis relative to the total mass of the food composition.

10. The food composition according to claim 7, which is frozen.

11. A kit for preparing the food composition according to claim 7, comprising pureed soybean curd (A), a heat coagulable substance (C) and lambda carrageenan (D) as components.

12. A method for producing a food composition, comprising the steps of providing a blend comprising pureed soybean curd (A), a foaming agent (B), a heat-coagulable substance (C), a stabilizer (D) and water and having air bubbles dispersed therein, and applying a heat treatment to the blend.

13. The method for producing the food composition according to claim 12, further comprising a step of freezing the blend after the heat treatment.

14. The method for producing the food composition according to claim 12, wherein pureed soybean curd (A) is tofu puree prepared by liquefying tofu until smooth.

15. The method for producing the food composition, according to claim 12, wherein the blend comprises the soy protein in an amount of 0.4 to 15% by mass on a dry basis and the stabilizer (D) in an amount of 0.01 to 5% by mass on a dry basis relative to the total mass of the food composition.

16. A method for producing a food composition, comprising the steps of preparing a blend comprising pureed soybean curd (A), a heat-coagulable substance (C), lambda carrageenan (D) and water, and applying a heat treatment to the blend.

17. The method for producing the food composition according to claim 16, further comprising a step of freezing the blend after the heat treatment.

18. The method for producing the food composition according to claim 16, wherein pureed soybean curd (A) is tofu puree prepared by liquefying tofu until smooth.

19. The method for producing the food composition according to claim 16, wherein the blend comprises the soy protein in an amount of 0.4 to 15% by mass on a dry basis and lambda carrageenan (D) in an amount of 0.01 to 5% by mass on a dry basis relative to the total mass of the food composition.
